(19) United States
(12) Patent Application Publication
(10) Pub. No.: US 2025/0158028 A1
(43) Pub. Date: May 15, 2025

(54) ELECTRODE PLATE, ELECTRODE ASSEMBLY AND SECONDARY BATTERY

(71) Applicant: SAMSUNG SDI CO., LTD., Yongin-si (KR)

(72) Inventor: Yeon Gap KIM, Suwon-si (KR)

(21) Appl. No.: 18/660,033

(22) Filed: May 9, 2024

(30) Foreign Application Priority Data
Nov. 15, 2023 (KR) 10-2023-0158115

(51) Int. Cl. H01M 4/36; H01M 4/02; H01M 10/04

(52) U.S. Cl. CPC H01M 4/366; H01M 10/0431; H01M 2004/021

(57) ABSTRACT

An electrode plate, an electrode assembly, and a secondary battery are disclosed. An electrode plate includes: a base; an active material layer formed on at least one surface of the base; and a pattern formed at one end of the active material layer, and the one end is a core portion of the electrode plate.

### CROSS-REFERENCE TO RELATED APPLICATION

The present application claims priority to and the benefit of Korean Patent Application No. 10-2023-0158115, filed on Nov. 15, 2023 in the Korean Intellectual Property Office, the entire disclosure of which is incorporated herein by reference.

### BACKGROUND

### 1. Field

Aspects of embodiments of the present invention relate to an electrode plate, an electrode assembly, and a secondary battery.

### 2. Description of the Related Art

A secondary battery is a battery that can be charged and discharged, unlike a primary battery that cannot be charged. Low-capacity secondary batteries may be used in small portable electronic devices, such as smartphones, feature phones, notebook computers, digital cameras, and camcorders, while large-capacity secondary batteries are widely used as power sources for driving motors and power storage batteries in hybrid and electric vehicles and the like. Such a secondary battery includes electrodes including a cathode and/or an anode, an electrode assembly including the electrodes, a case receiving the electrode assembly therein, and electrode terminals connected to the electrode assembly.

With the recent development of science and technology, secondary batteries are applied to various devices. As a result, there is a need for high performance secondary batteries with low resistance and high output. As measures for reducing resistance of such a secondary battery, the number of tabs of the secondary battery may be increased. However, such a secondary battery with leading end tabs may have problems of an increase in internal stress and vulnerability to deformation.

This section is intended to provide a better understanding of the background of the invention and thus may include information which is not necessarily prior art.

### SUMMARY

According to aspects of embodiments of the present invention, an electrode plate having a pattern formed on at least a portion thereof, an electrode assembly including an electrode plate, and a secondary battery including an electrode assembly are provided.

According to another aspect of embodiments of the present invention, an electrode plate, an electrode assembly, and/or a secondary battery having improved characteristics in deformation of a core portion thereof are provided. According to an aspect of embodiments of the present invention, an electrode plate suppressing deformation is provided.

According to another aspect of embodiments of the present invention, an electrode plate, an electrode assembly, and/or a secondary battery having improved characteristics in electrolyte impregnation and/or ion mobility are provided.

According to another aspect of embodiments of the present invention, an electrode plate, an electrode assembly, and/or a secondary battery having an increased reaction surface area are provided.

The above and other aspects and features of the present invention will become apparent from the following description of some embodiments of the present invention.

According to one or more embodiments of the present invention, an electrode plate includes: a base; and an active material layer formed on at least one surface of the base; wherein the electrode plate comprises a pattern formed at one end of the electrode plate, wherein the one end is a core portion side of the electrode plate.

According to one or more embodiments of the present invention, an electrode assembly includes a cathode, an anode, and a separator between the cathode and the anode to form a jelly roll shape, wherein at least one of the cathode and the anode includes a base; an active material layer formed on at least one surface of the base; and a pattern formed at one end of a surface of the active material layer, the one end being a core portion side of the jelly roll shape.

According to one or more embodiments of the present invention, a secondary battery includes: a case receiving the electrode assembly according to an embodiment of the present invention.

According to one or more embodiments of the present invention, an electrode plate, an electrode assembly, and/or a secondary battery that prevents (prevent or substantially prevents) a short circuit at a leading end thereof is provided.

According to one or more embodiments of the present invention, an electrode plate, an electrode assembly, and/or a secondary battery that secures high power and/or rapid charge characteristics is provided.

According to one or more embodiments of the present invention, an electrode plate, an electrode assembly, and/or a secondary battery that reduces precipitation of lithium (Li) ions is provided.

According to one or more embodiments of the present invention, an electrode assembly, and/or a secondary battery that secures improvement in rapid charge life span is provided.

According to one or more embodiments of the present invention, a battery pack including a secondary battery with an improved structure and/or an automobile including such a battery pack is provided.

However, aspects and features of the present invention are not limited to those described above, and other aspects and features not mentioned will be clearly understood by those skilled in the art from the detailed description provided below.

### BRIEF DESCRIPTION OF THE DRAWINGS

The following drawings attached to this specification illustrate some embodiments of the present invention, and further describe aspects and features of the present invention together with the below detailed description of the present invention. However, the present invention should not be construed as being limited to the drawings.

FIG. 1 is a perspective view of a cylindrical battery according to an embodiment of the present invention;

FIG. 2 is a cross-sectional view of the cylindrical battery of FIG. 1;

FIG. 3 is a schematic view of an electrode plate according to an embodiment of the present invention;

FIG. 4 is a schematic view of an electrode assembly according to an embodiment of the present invention;

FIGS. 5A to 5C are schematic views of electrode plates according to embodiments of the present invention;

FIG. 6 is a table showing performance of electrode plates according to embodiments of the present invention;

FIG. 7 is a schematic view of an electrode plate according to an embodiment of the present invention;

FIG. 8 is a schematic view of an electrode assembly according to an embodiment of the present invention;

FIG. 9 is a perspective view of a battery pack according to an embodiment of the present invention; and

FIG. 10A and FIG. 10B are views of a vehicle body and body parts according to some embodiments of the present invention.

### DETAILED DESCRIPTION

Herein, some example embodiments of the present invention will be described, in further detail, with reference to the accompanying drawings. However, the terms or words used in this specification and claims should not be construed as being limited to the usual or dictionary meaning and should be interpreted as having meanings and concepts consistent with the technical idea of the present invention based on the principle that the inventor can be his/her own lexicographer to appropriately define the concept of the term to explain his/her invention in the best way. The embodiments described in this specification and the configurations shown in the drawings are some example embodiments of the present invention and do not represent all of the technical ideas, aspects, and features of the present invention. Accordingly, it is to be understood that there may be various equivalents and modifications that can replace or modify the embodiments described herein at the time of filing this application.

It is to be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

In the figures, dimensions of the various elements, layers, etc. may be exaggerated for clarity of illustration. The same reference numerals designate the same elements.

References to two compared elements, features, etc. as being “the same” may mean that they are “substantially the same.” Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

It is to be understood that, although the terms “first,” “second,” “third,” etc. may be used herein to describe various elements, components, regions, layers, and/or sections, these elements, components, regions, layers, and/or sections are not to be limited by these terms. These terms are used to distinguish one element, component, region, layer, or section from another element, component, region, layer, or section. Thus, a first element, component, region, layer, or section discussed below could be termed a second element, component, region, layer, or section, unless specified otherwise.

Throughout the specification, unless specified otherwise, each element may be singular or plural.

When an arbitrary element is referred to as being disposed (or located or positioned) “above” (or “below”) or “on” (or “under”) a component, it may mean that the arbitrary element is placed in contact with the upper (or lower) surface of the component and may also mean that another component may be interposed between the component and any arbitrary element disposed (or located or positioned) on (or under) the component.

In addition, it is to be understood that, when an element is referred to as being “coupled,” “linked,” or “connected” to another element, the elements may be directly “coupled,” “linked,” or “connected” to each other, or one or more intervening elements may be present therebetween, through which the element may be “coupled,” “linked,” or “connected” to another element. In addition, when a part is referred to as being “electrically coupled” to another part, the part may be directly connected to another part or one or more intervening parts may be present therebetween such that the part and the another part are indirectly connected to each other.

Throughout the specification, when “A and/or B” is stated, it means A, B, or A and B, unless stated otherwise. That is, “and/or” includes any or all combinations of a plurality of items enumerated. When “C to D” is stated, it means C or more and D or less, unless specified otherwise.

The terminology used herein is for the purpose of describing embodiments of the present invention and is not intended to be limiting of the present invention.

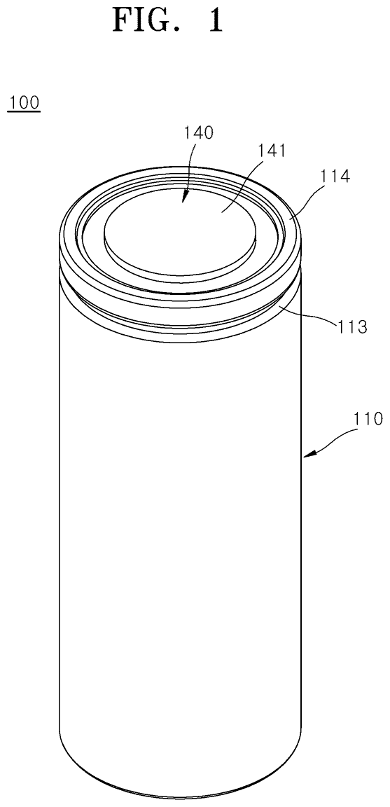

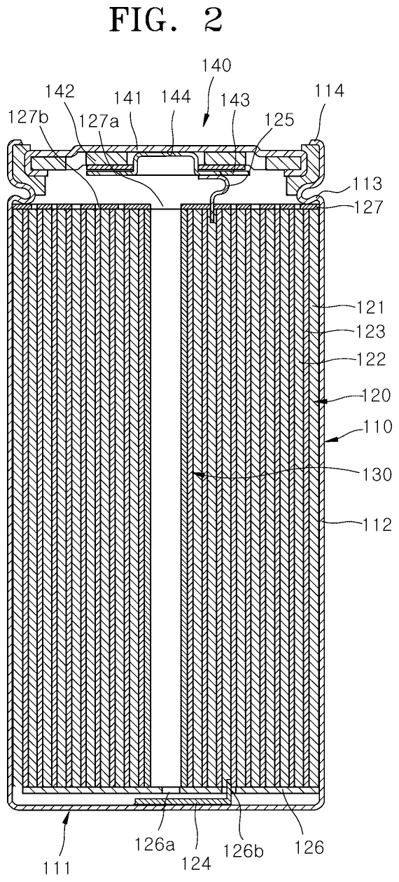

FIG. 1 is a perspective view of a cylindrical battery according to an embodiment of the present invention; and FIG. 2 is a cross-sectional view of the cylindrical battery of FIG. 1.

Referring to FIG. 1 and FIG. 2, a cylindrical lithium-ion secondary battery 100 according to one or more embodiments of the present invention may include a cylindrical can 110, an electrode assembly 120, and a cap assembly 140. In one or more embodiments, the cylindrical lithium-ion secondary battery 100 may further include a center pin 130. In the secondary battery 100 according to one or more embodiments of the present invention, the cap assembly 140 performs a current interrupt operation and is thus sometimes referred to as a current interrupt device.

The cylindrical can 110 may include a substantially circular bottom portion 111 and a cylindrical sidewall 112 extending by a certain length upward from a circumference of the bottom portion 111. In a manufacturing process of the secondary battery, the cylindrical can 110 is open at an upper side thereof. Accordingly, in assembly of the secondary battery, the electrode assembly 120 and the center pin 130 may be inserted into the cylindrical can 110 together with an electrolyte. The cylindrical can 110 may be made of, for example, steel, stainless steel, aluminum, an aluminum alloy, or equivalent materials thereto, without being limited thereto.

In addition, the cylindrical can 110 may include an inwardly recessed beading portion 113 formed below the cap assembly 140 and an inwardly bent crimping portion 114 formed above the cap assembly 140 to prevent or substantially prevent separation of the cap assembly 140.

The electrode assembly 120 may be received within the cylindrical can 110. The electrode assembly 120 may include an anode plate 121 with an anode material (for example, graphite, carbon, or the like) coated on an anode current collector plate, a cathode plate 122 with a cathode material (for example, a transition metal oxide, such as LiCoO₂, LiNiO₂, LiMn₂O₄, or the like) coated on a cathode current collector plate, and a separator 123 interposed between the anode plate 121 and the cathode plate 122 to prevent or substantially prevent a short circuit and allow migration of lithium ions only. In an embodiment, the anode plate 121, the cathode plate 122, and the separator 123 may be rolled into a substantially cylindrical shape. By way of example, the anode current collector plate may be made of copper (Cu) foil, the cathode current collector plate may be made of aluminum (Al) foil, and the separator may be made of polyethylene (PE) or polypropylene (PP).

In addition, the anode plate 121 may have an anode tab 124 (e.g., welded to a lower portion thereof) to protrude therefrom and extending a certain length, and the cathode plate 122 may have a cathode tab 125 (e.g., welded to an upper portion thereof) to protrude therefrom and extending a certain length, or vice versa. In an embodiment, by way of example, the anode tab 124 may be formed of copper (Cu) or nickel (Ni), and the cathode tab 125 may be formed of aluminum (Al), without being limited thereto.

Further, the anode tab 124 of the electrode assembly 120 may be welded to the bottom portion 111 of the cylindrical can 110. Thus, the cylindrical can 110 may function as an anode. In another embodiment, the cathode tab 125 may be welded to the bottom portion 111 of the cylindrical can 110 to allow the cylindrical can 110 to function as a cathode.

Further, a first insulating plate 126 may be coupled to the cylindrical can 110 to be interposed between the electrode assembly 120 and the bottom portion 111 and may be formed with a first hole 126a at a central portion thereof and a second hole 126b around the central portion. The first insulating plate 126 prevents or substantially prevents the electrode assembly 120 from electrically contacting the bottom portion 111 of the cylindrical can 110. In particular, the first insulating plate 126 prevents or substantially prevents the cathode plate 122 of the electrode assembly 120 from electrically contacting the bottom portion 111. The first hole 126a allows gas to quickly move upward through the center pin 130 in the event that a large amount of gas is generated by an abnormality of the secondary battery, and the second hole 126b allows the anode tab 124 to be welded to the bottom portion 111 therethrough.

Further, a second insulating plate 127 may be coupled to the cylindrical can 110 to be interposed between the electrode assembly 120 and the cap assembly 140 and may be formed with a first hole 127a at a central portion thereof and a plurality of second holes 127b around the central portion. The second insulating plate 127 prevents or substantially prevents the electrode assembly 120 from electrically contacting the cap assembly 140. In particular, the second insulating plate 127 prevents or substantially prevents the anode plate 121 of the electrode assembly 120 from electrically contacting the cap assembly 140. The first hole 127a allows gas to quickly move into the cap assembly 140 in the event that a large amount of gas is generated by an abnormality of the secondary battery, and a second hole 127b allows the cathode tab 125 to be welded to the cap assembly 140 therethrough. In an embodiment, the other second holes 127b allow an electrolyte to quickly flow into the electrode assembly 120 in an electrolyte injection process.

In an embodiment, the first holes 126a, 127a of the first and second insulating plates 126, 127 have smaller diameters than the center pin 130, thereby preventing or substantially preventing the center pin 130 from electrically contacting the bottom portion 111 of the cylindrical can 110 or the cap assembly 140 by external impact.

In an embodiment, the center pin 130 may have a hollow circular pipe shape and may be coupled to a center or approximate center of the electrode assembly 120. Such a center pin 130 may be made of, for example, steel, stainless steel, aluminum, an aluminum alloy, or polybutylene terephthalate, without being limited thereto. The center pin 130 may restrain deformation of the electrode assembly 120 during charge and discharge of the battery and functions as a discharge channel of gas generated inside the secondary battery. However, in some embodiments, the center pin 130 may be omitted.

The cap assembly 140 may include a top plate 141, a middle plate 142, an insulating plate 143, and a bottom plate 144.

The middle plate 142 is disposed under the top plate 141 and may have a substantially flat shape.

The insulating plate 143 may be formed in a circular ring shape with a constant width, when viewed from the bottom. In addition, the insulating plate 143 insulates the middle plate 142 and the bottom plate 144 from each other. For example, the insulating plate 143 may be interposed between the middle plate 142 and the bottom plate 144 and may be coupled thereto by ultrasonic welding, for example, without being limited thereto.

However, it is to be understood that the present invention is not limited thereto and the case may have any of various shapes, such as a circular shape, a pouch shape, and the like. In addition, the case may be made of a metal, such as any of aluminum, an aluminum alloy, nickel-plated steel, a laminated film or plastic film that constitutes a pouch, and the like.

The lithium secondary battery 100 according to an embodiment of the present invention has been described with reference to FIG. 1 and FIG. 2. Herein, the electrode assembly 120 of the secondary battery 100 and the anode plate 121 and/or the cathode plate 122 of the electrode assembly 120 will be described.

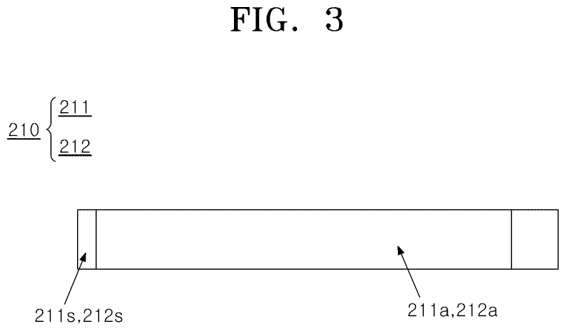

FIG. 3 is a schematic view of an electrode plate according to an embodiment of the present invention.

FIG. 3 shows an electrode plate 210 according to an embodiment of the invention. The electrode plate 210 includes, for example, an anode 211 (for example, the anode plate 121 in FIG. 1 and FIG. 2) and/or a cathode 212 (for example, the cathode plate 122 in FIG. 1 and FIG. 2).

The anode 211 includes a base 211s and an anode material layer 211a formed on the base 211s.

For example, the base 211s of the anode 211 is an anode current collector. The anode current collector may be selected from among copper foil, nickel foil, stainless steel foil, titanium foil, nickel foam, copper foam, a polymer base coated with a conductive metal, and combinations thereof.

The anode material layer 211a includes an anode material and may further include a binder and/or a conductive material.

For example, the anode material layer may include 90 wt % to 99 wt % of the anode material, 0.5 wt % to 5 wt % of the binder, and optionally 5 wt % or less of the conductive material.

The anode material includes a material allowing reversible intercalation/deintercalation of lithium ions, lithium metal, lithium metal alloys, a material capable of being doped to lithium and de-doped therefrom, or a transition metal oxide.

The material allowing reversible intercalation/deintercalation of lithium ions may include a carbon-based anode material, for example, crystalline carbon, amorphous carbon, or a combination thereof. The crystalline carbon may include, for example, graphite, such as natural graphite and/or artificial graphite, and the amorphous carbon may include, for example, any of soft carbon, hard carbon, mesoporous pitch carbides, calcined coke, and the like.

The material capable of being doped to lithium and de-doped therefrom may be an Si-based anode material or an Sn-based anode material. The Si-based anode material may be silicon, a silicon-carbon composite, SiOₓ (0<x<2), Si alloys, or a combination thereof.

The silicon-carbon composite may be a composite of silicon and amorphous carbon. According to an embodiment, the silicon-carbon composite may be realized in the form of silicon particles and amorphous carbon-coated silicon particles.

The silicon-carbon composite may further include crystalline carbon. For example, the silicon-carbon composite may include a core containing crystalline carbon and silicon particles and an amorphous carbon coating layer formed on the core.

The binder may be a non-aqueous binder, an aqueous binder, a dry binder, or a combination thereof. When the aqueous binder is used as the binder, the binder may further include a cellulose compound capable of imparting viscosity.

The cathode 212 may include a base 212s and a cathode material layer 212a formed on the base 212s.

The base 212s of the cathode 212 is, for example, a current collector. The current collector may be formed of Al, without being limited thereto.

The cathode material layer 212a includes a cathode material and may further include a binder and/or a conductive material.

For example, the cathode material may be present in an amount of 90 wt % to 99.5 wt % based on 100 wt % of the cathode material layer, and each of the binder and the conductive material may be present in an amount of 0.5 wt % to 5 wt % based on 100 wt % of the cathode material layer.

As the cathode material, a compound enabling reversible intercalation and deintercalation of lithium (lithiated intercalation compound) may be used. In an embodiment, the cathode material may be at least one complex oxide of a metal selected from among cobalt, manganese, nickel, and combinations thereof, with lithium.

The composite oxide may be a lithium transition metal composite oxide. In an embodiment, the composite oxide may be a lithium nickel oxide, a lithium cobalt oxide, a lithium manganese oxide, a lithium iron phosphate compound, a cobalt-free nickel-manganese oxide, or a combination thereof.

By way of example, the composite oxide may be a compound represented by any of the following formulas: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, ≤b≤0.5, 0≤c≤50.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, ≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the above formulas, A is Ni, Co, Mn, or a combination thereof; X is Al, Ni, Co, Mn, Cr, Fe, Mg, Sr, V, a rare earth element, or a combination thereof; D is 0, F, S, P, or a combination thereof; G is Al, Cr, Mn, Fe, Mg, La, Ce, Sr, V, or a combination thereof; and L¹ is Mn, Al, or a combination thereof.

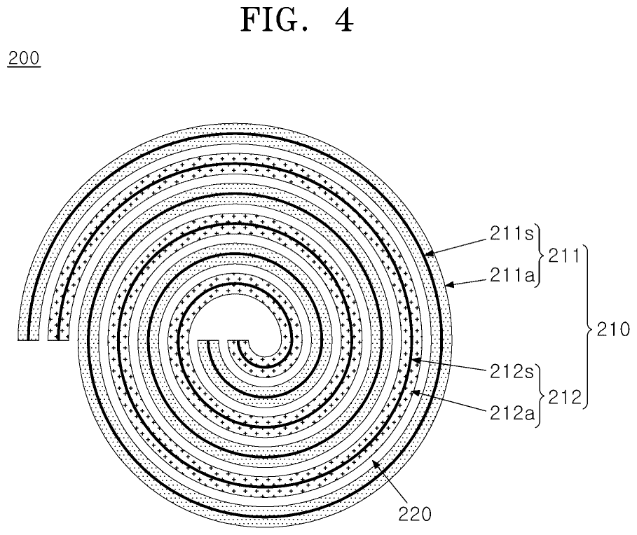

The electrode plate according to an embodiment of the present invention has been described with reference to FIG. 3. FIG. 4 shows an electrode assembly 200 including such an electrode plate 210.

FIG. 4 is a schematic view of an electrode assembly according to an embodiment of the present invention.

Referring to FIG. 4, the electrode assembly 200 according to an embodiment of the invention (for example, including the electrode assembly 120 in FIG. 1 and FIG. 2) is formed in a jelly roll shape.

The electrode assembly 200 may include electrodes 210 and a separator 220 interposed between the electrodes 210. In addition, although not shown in FIG. 4, the electrode assembly 200 may further include an electrolyte. The electrodes 210 may be the same or similar to the electrode plate 210 shown in FIG. 3.

Depending on the kind of secondary battery (for example, including the lithium secondary battery 100 in FIG. 1 and FIG. 2), the separator 220 may be interposed between the cathode 212 and the anode 211. As such a separator 220, a multilayer membrane of polyethylene, polypropylene, polyvinylidene fluoride, or two or more layers thereof may be used.

The separator 220 may include a porous base and a coating layer formed on one or both surfaces of the porous base and including an organic material, an inorganic material, or a combination thereof.

The organic material may include a polyvinylidene fluoride polymer or a (meth)acrylic polymer.

The inorganic material may include inorganic particles selected from among Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof, without being limited thereto.

The organic material and the inorganic material may be present in a mixed state in a coating layer or in the form of a stack structure of a coating layer containing the organic material and a coating layer containing the inorganic material.

The electrolyte for the lithium secondary battery 100 includes a non-aqueous organic solvent and a lithium salt.

The non-aqueous organic solvent functions as a medium through which ions involved in an electrochemical reaction of the battery can migrate.

The non-aqueous organic solvent may be a carbonate solvent, an ester solvent, an ether solvent, a ketone solvent, an alcohol solvent, a non-amphoteric solvent, or a combination thereof, and may be used alone or as a mixture thereof.

In addition, a mixture of cyclic and chain carbonates may be used as the carbonate solvent.

The electrode plate according to an embodiment of the present invention has been described with reference to FIG. 3 and FIG. 4. As described with reference to FIG. 3, the electrode plate is rolled together with the separator, the electrolyte, and the like to form a jelly roll-shaped electrode assembly.

Here, a curvature portion (R portion) is formed on the electrode plate during a rolling process. The curvature portion undergoes stress in the process of rolling the flat electrode plate. In particular, a core portion corresponding to a roll core of the jelly roll shape is subjected to greater stress than other regions of the curvature portion. Due to the stress, the electrode plate may be deformed. Accordingly, measures capable of suppressing deformation of the electrode plate while improving performance of the electrode plate are desired. Herein, these measures will be described in further detail.

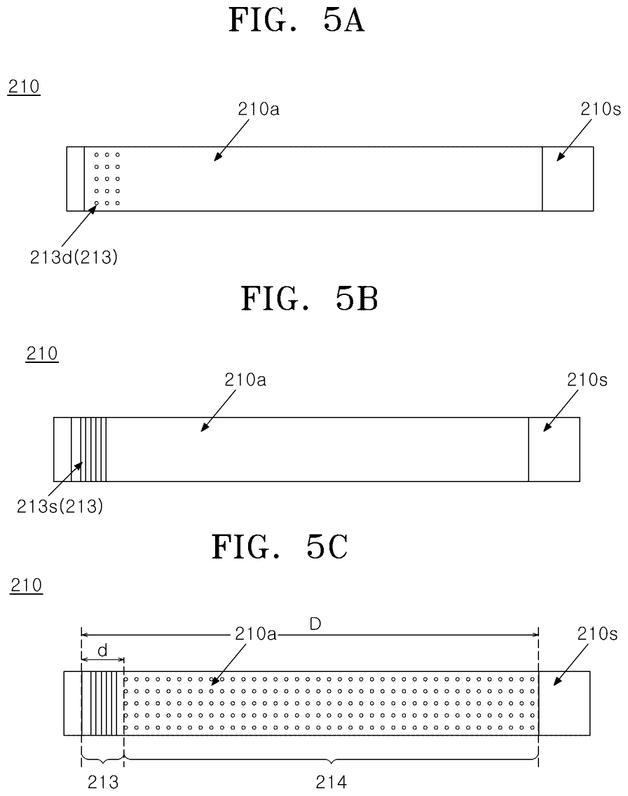

FIGS. 5A to 5C are schematic views of electrode plates according to embodiments of the present invention.

Referring to FIGS. 5A to 5C, reference numeral 210 denotes an electrode plate. As illustrated in FIG. 3 and FIG. 4, the electrode plate 210 includes the anode 211 and the cathode 212. However, in the following description with reference to FIGS. 5A to 5C, for convenience of description, the electrode plate 210 will be described without dividing the electrode plate into the anode 211 and the cathode 212. Accordingly, FIGS. 5A to 5C and the following description are applied to the anode 211 and/or the cathode 212.

As shown in FIGS. 5A to 5C, the electrode plate 210 includes a base 210s and an active material layer 210a formed on at least one surface of the base 210s. Further, the electrode plate 210 includes one or more patterns 213 at a first end thereof.

The pattern 213 is formed on the electrode plate 210 to be disposed at the first end of the electrode plate 210. Here, when the electrode plate 210 is formed in a jelly roll shape, for example, as shown in FIG. 4, the first end of the electrode plate 210 refers to an end placed at a core portion (central portion) side of the jelly roll shape.

For example, the pattern 213 is formed on a surface of the active material layer 210a. In an embodiment, the pattern 213 includes any of patterns concavely recessed from a surface of the active material layer 210a. In another embodiment, the pattern 213 includes any of patterns convexly protruding from the surface of the active material layer 210a. In another embodiment, the pattern 213 includes flat patterns printed in the form of perforations on the surface of the active material layer 210a. However, by way of example, the pattern 213 formed in a concavely recessed shape will be described for convenience of description.

The pattern 213 is formed on the active material layer 210a by, for example, the following method. For example, the pattern 213 may be formed by rollers having protrusions corresponding to the pattern 213. In an embodiment, the base 210s having the active material layer 210a formed thereon is subjected to drawing, rolling, and withdrawal between the rollers having the protrusions thereon. As a result, the pattern 213 is formed on the active material layer 210a. In another embodiment, for example, the pattern 213 is formed by a stamp in which protrusions corresponding to the pattern 213 are formed. Here, the pattern 213 may be formed by applying pressure to the stamp toward the active material layer 210a. By pressing the surface of the active material to form the pattern 213 in this way, it is possible to form the pattern 213 on the electrode plate 210 without loss of the active material layer 210a or the active material. However, it is to be understood that the present invention is not limited thereto, and the pattern 213 may be formed by any method that can form the pattern 213 in a concave and/or convex shape on the active material layer 210a.

Some examples of the pattern 213 will be described with reference to FIG. 5A and FIG. 5B.

FIG. 5A is a view of an example in which the pattern 213 is formed in the form of dots.

Referring to FIG. 5A, the pattern 213 includes a pattern in the form of dots 213d. For example, the pattern 213 includes a plurality of dots 213d arranged at certain intervals. In an embodiment, the plurality of dots 213d may be equally spaced apart from each other in a longitudinal direction and/or a transverse direction. In another embodiment, the plurality of dots 213d may be arranged at different intervals in a direction of the longitudinal and transverse directions while being arranged at constant intervals in a direction of the longitudinal and transverse directions. In another embodiment, the plurality of dots 213d may be arranged at different intervals in the longitudinal and transverse directions, for example, so as to be randomly arranged.

Although not shown in detail in FIG. 5A, the dots 213d may be formed, for example, in a conical shape, a cylindrical shape, or the like. Although the dots 213d having a circular shape are shown in FIG. 5A, the dots 213d may be formed in a polygonal shape, such as a rectangular shape, a triangular shape, or the like in a plan view. Accordingly, the dots 213d may be formed in a faceted cone shape, a faceted column shape, or the like.

The dots 213d are formed to a depth of, for example, 2 μm to 100 μm. In an embodiment, the dots 213d are formed at an interval of, for example, 10 μm to 50 μm. In an embodiment, the dots 213d are formed to a diameter of, for example, 50 μm to 100 μm. In an embodiment, the dots 213d are formed at a hole density of, for example, 4 pt/mm² to 625 pt/mm². However, it is to be understood that these are provided by way of example to illustrate an arrangement, shape, or size of one or more dots 213d, and the present invention is not limited thereto.

FIG. 5B is a view of an example in which the pattern 213 is a pattern in the form of stripes.

Referring to FIG. 5B, the pattern 213 includes a pattern in the form of one or more stripes 213s. For example, the pattern 213 may include a single stripe or a plurality of stripes 213s arranged at certain intervals. The plurality of stripes 213s may be arranged at the same or different intervals.

As shown in FIG. 5B, in an embodiment, at least one of the one or more stripes 213s is formed from a first side to a second side of the active material layer 210a in a transverse direction thereof. In another embodiment, at least one of the one or more stripes 213s is formed from a side near a first side of the active material layer 210a to a side near a second side thereof in the transverse direction thereof, unlike the structure shown in FIG. 5B. In another embodiment, at least one of the one or more stripes 213s is formed from a side near a first side of the active material layer 210a to a second side thereof in the transverse direction thereof. That is, the one or more stripes 213s have a same length as or a smaller length than a short side of the active material layer 210a.

Although not shown in detail in FIG. 5B, the one or more stripes 213s may be formed, for example, in a quadrangular pyramid shape, a quadrangular column shape, or the like. The stripes 213s are formed to a depth of, for example, 2 μm to 100 μm. In an embodiment, the stripes 213s are formed at an interval of, for example, 10 μm to 50 μm. In an embodiment, the stripes 213s are formed to have a width of, for example, 50 μm to 100 μm. However, it is to be understood that these are provided by way of example to illustrate an arrangement, shape, or size of the one or more stripes 213s, and the present invention is not limited thereto.

With the pattern 213 formed at a side of the surface of the active material layer 210a, as shown in FIG. 5A and FIG. 5B, the electrode plates according to the embodiments of the invention can suppress deformation of the core portion of the jelly roll shape. Further, the electrode plates according to embodiments of the present invention have an increased surface area, thereby improving an electrolyte impregnation rate while reducing a precipitation amount of lithium ions.

FIG. 5C is a view of an example of additional patterns formed on the active material layer 210a.

In an embodiment, the electrode plate 210 may further include a sub-pattern 214.

The sub-pattern 214 is formed on the electrode plate 210. The sub-pattern 214 is formed from the pattern 213 toward the second end of the electrode plate 210. Here, when the electrode plate 210 is formed in a jelly roll shape, for example, as shown in FIG. 4, the second end of the electrode plate 210 refers to an end placed at a rolled distal end (outer periphery) of the jelly roll shape. For example, the sub-pattern 214 may be formed on the electrode plate 210 at regular intervals from the core portion side to the rolled distal end.

For example, the sub-pattern 214 is formed on the surface of the active material layer 210a. The sub-pattern 214 is formed from the first side of the active material layer 210a formed with the pattern 213 toward the second side of the surface of the active material layer 210a. An arrangement, shape, or size of the patterns included in the sub-pattern 214 may be the same or similar to the arrangement, shape, or size of the patterns included in the pattern 213 (for example, dot shape, stripe shape).

For example, as shown in FIG. 5C, the pattern 213 includes a pattern in the form of one or more stripes spaced apart from each other. Further, the sub-pattern 214 includes a dot-shaped pattern. Here, the active material layer 210a has the stripe-shaped patterns 213 at the first side of the surface thereof, and the dot-shaped sub-pattern 214 formed from the first side of the surface toward the second side of the surface. In this way, the active material layer 210a may have the patterns formed in different arrangements, shapes, or sizes on the surface thereof.

Although FIG. 5C shows an embodiment in which the pattern 213 is formed in a stripe shape and the sub-pattern 214 is formed in a dot shape, it is to be understood that the present invention is not limited thereto. For example, the pattern 213 and/or the sub-pattern 214 may be formed the form of dots or stripes. That is, the pattern 213 and the sub-pattern 214 may have a same or similar shape.

With the pattern 213 and the sub-pattern 214 formed on the surface of the active material layer 210a, as shown in FIG. 5C, the electrode plate according to one or more embodiments of the present invention can further suppress deformation of the core portion of the jelly roll while improving rapid charge performance. Further, the electrode plate according to one or more embodiments of the present invention has an increased surface area, thereby improving the electrolyte impregnation rate while reducing the precipitation amount of lithium ions.

As shown in FIGS. 5A to 5C, the one or more patterns 213 are formed within a range (e.g., a predetermined range) d from at least one end of the surface of the active material layer 210a. The range d is a region corresponding to a rolled portion (or a region near the rolled portion) when the electrode plate 210 is rolled into the jelly roll shape. For example, the range d is a region corresponding to the first side of the surface of the active material layer. In an embodiment, for example, the range d is a region in the range of 20% or less of a total length D of the surface of the active material layer. In an embodiment, the range d is a region in the range of 20% or less of the total length D of the surface of the active material layer 210a from the first side of the surface of the active material layer. In an embodiment, for example, the range d is a region in the range of 5% to 10% of the total length D of the surface of the active material layer. In an embodiment, the range d is a region in the range of 5% to 10% of the total length D of the surface of the active material layer 210a from the first side of the surface of the active material layer 210a. Here, the total length D of the surface of the active material layer is a length in the longitudinal direction of the surface of the active material layer 210a. Thus, on the surface of the active material layer 210a, a pattern formed within the range d may be referred to as the pattern 213 and a pattern formed outside the range d may be referred to as the sub-pattern 214.

With the one or more patterns 213 within the ranged, the electrode plate can further suppress deformation of the core portion of the electrode assembly 200 including the electrode plate 210.

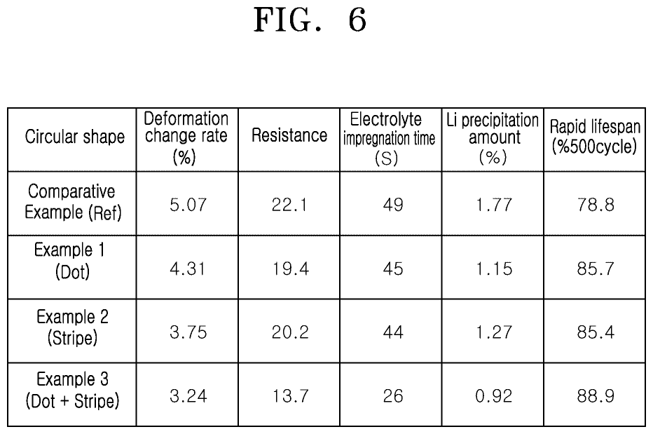

FIG. 6 is a table showing performance of the electrode plates according to embodiments of the present invention.

FIG. 6 is a tabular representation of performance difference between the electrode plates 210 according to embodiments of the present invention shown in FIG. 5A to 5C and a typical electrode plate.

In FIG. 6, a comparative example is an electrode plate in which no pattern is formed on the surface of the active material layer.

In FIG. 6, Example 1 is an example of the electrode plate shown in FIG. 5A, in which the dot-shaped pattern 213 is formed on the active material layer 210a. In FIG. 6, Example 2 is an example of the electrode plate shown in FIG. 5B, in which the stripe-shaped pattern 213 is formed on the active material layer 210a. In FIG. 6, Example 3 is an example of the electrode plate shown in FIG. 5C, in which the stripe-shaped pattern 213 and the dot-shaped sub-pattern 214 are formed on the active material layer 210a.

In FIG. 6, the electrode plates of Examples 1 to 3 include the engraved pattern 213 formed to a depth of 15 μm to 55 μm. Each of the electrode plates 210 of Example 1 and Example 3 includes the dot-shaped pattern formed over the entire range of the electrode plate 210, or over the electrode plate 210 except for a region in which the stripe-shaped pattern is formed. Here, the dot-shaped pattern may be formed at an interval of 100 pt/mm² to 625 pt/mm². In addition, each of the electrode plates 210 of Example 2 and Example 3 includes the stripe-shaped pattern formed on the leading end (rolled portion shown in FIGS. 5B and 5C) within 10% of the entire length of the electrode plate 210. The stripe-shaped pattern may be formed at intervals of 30 μm to 200 μm.

Here, performance of the electrode plate includes a deformation change rate (%), resistance (Ω/cm²), an electrolyte impregnation time (s), a lithium (Li) precipitation amount (%), and/or rapid charge lifespan (%@500 cycles).

As shown in FIG. 6, it can be seen that Example 1 exhibits a decrease in deformation change rate from 5.07% to 4.31%, as compared to the comparative example. Example 2 exhibits a decrease in deformation change rate from 5.07% to 3.75%, as compared to the comparative example. Example 3 exhibits a decrease in deformation change rate from 5.07% to 3.24%, as compared to the comparative example. Here, the deformation change rate indicates the degree of deformation that the core portion of the jelly roll undergoes. Specifically, the deformation change rate is a measurement of change in length of the circumference of the core portion before and after charge lifespan (SOH90, SOH80). As can be seen from FIG. 6, the Examples according to the present invention have a smaller degree of deformation in the core portion than the comparative example.

In addition, it can also be seen that Example 1 exhibits a decrease in resistance (Ω/cm²) from 22.1 Ω/cm² to 19.4 Ω/cm², as compared to the comparative example. Example 2 exhibits a decrease in resistance (Ω/cm²) from 22.1 Ω/cm² to 20.2 Ω/cm², as compared to the comparative example. Example 3 exhibits a decrease in resistance (Ω/cm²) from 22.1 Ω/cm² to 13.7 Ω/cm², as compared to the comparative example. Here, the resistance indicates resistance of a cell into which the jelly roll-shaped electrode assembly 200 is inserted. Specifically, the resistance is ionic resistance and measured by a two-probe method using an impedance analyzer (Solartron 1260A Impedance/Gain-Phase Analyzer) at 25° C. From FIG. 6, it can be seen that the Examples according to the present invention contribute to a high-performance cell with lower resistance and higher output than the comparative example.

Further, it can be seen that Example 1 exhibits a decrease in electrolyte impregnation time (s) from 49 seconds to 45 seconds, as compared to the comparative example. Example 2 exhibits a decrease in electrolyte impregnation time (s) from 49 seconds to 44 seconds, as compared to the comparative example. Example 3 exhibits a decrease in electrolyte impregnation time (s) from 49 seconds to 26 seconds, as compared to the comparative example. Here, the electrolyte impregnation time (s) is indicative of the electrolyte impregnation rate. Specifically, the electrolyte impregnation time (s) is measured by dropping the electrolyte onto the electrode plate. As can be seen from FIG. 6, the Examples according to the present invention have better impregnation characteristics than the comparative example.

It can also be seen that Example 1 exhibits a decrease in precipitation amount (%) of lithium ions (Li) from 1.77% to 1.15%, as compared to the comparative example. Example 2 exhibits a decrease in precipitation amount (%) of lithium ions (Li) from 1.77% to 1.27%, as compared to the comparative example. Example 3 exhibits a decrease in precipitation amount (%) of lithium ions (Li) from 1.77% to 0.92%, as compared to the comparative example. Here, the precipitation amount of lithium ions indicates the extent of precipitation of lithium ions on the surface of the electrode (for example, on the surface of the anode 211) due to repeated rapid charge and discharge. Specifically, the precipitation amount (%) of lithium ions is indicative of the amount of reversible Li precipitated on the surface of the anode during rapid charge, which is quantified by low rate discharging after rapid charge without CV and rest intervals to determine an inflection point. As can be seen in FIG. 6, the Examples according to the present invention undergo less precipitation of lithium ions than the comparative example.

Further, it can be seen that Example 1 exhibits improvement in rapid charge lifespan (%@500 cycles) from 78.8% to 85.7% per 500 cycles, as compared to the comparative example. Example 2 exhibits improvement in rapid lifespan from 78.8% to 85.4% per 500 cycles, as compared to the comparative example. Example 3 exhibits improvement in rapid lifespan from 78.8% to 88.9% per 500 cycles, as compared to the comparative example. Here, the rapid lifespan of the electrode plate is evaluated by, for example, 2N1F, according to specification, such as No. 2 normal condition (0.5 C charging)+No. 1 rapid condition (charge by changing the C-rate according to the charge time, such as 10 minutes, 13 minutes, 15 minutes, and the like). That is, it can be seen that the Examples according to the present invention have better rapid lifespan than the comparative example.

As such, it can be seen that the Examples according to the present invention achieved high power and rapid charge characteristics, reduction in precipitation of lithium ions, and improvement in rapid charge lifespan, as compared to the comparative example. Further, it can be seen that the Examples according to the present invention had improved deformation characteristics of the core portion, as compared to the comparative example.

Further, as shown in FIG. 6, it can be seen that the secondary battery has better performance when the electrode plate 210 includes both the pattern 213 and the sub-pattern 214 than when the electrode plate includes only the pattern 213. As such, the electrode plate according to embodiments of the invention can provide measures and various structures that satisfy target performance of the secondary battery including the electrode plate.

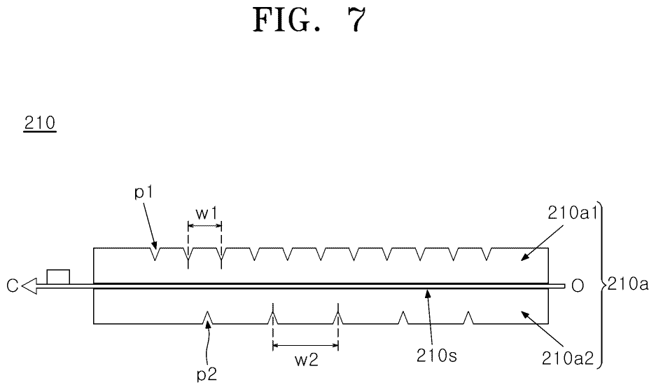

FIG. 7 is a schematic view of an electrode plate according to an embodiment of the present invention.

FIG. 5 and FIG. 6 show the electrode plate 210 according to an embodiment of the present invention, which includes the active material layer 210a on one surface of the base 210s. FIG. 7 shows an embodiment in which the electrode plate 210 includes a base 210s and active material layers 210a formed on both, or opposite, surfaces of the base 210s. Further, in FIG. 7, C indicates a side close to a central portion (for example, the core portion) of a jelly roll shape, and O indicates a side close to the outer periphery of the jelly roll shape, when the electrode plate 210 is rolled into the jelly roll shape.

Referring to FIG. 7, the active material layers 210a include a first active material layer 210a1 and a second active material layer 210a2. The first active material layer 210a1 is formed on a first surface of the base 210s. The second active material layer 210a2 is formed on a second surface of the base 210s. Description of the active material layers 210a1, 210a2 may be the same or similar to that described with reference to FIG. 1 to FIG. 6.

The first active material layer 210a1 includes a plurality of first patterns p1 on a surface thereof. The first patterns p1 correspond to the patterns 213 and/or the sub-patterns 214 shown in FIGS. 5A to 5C and a description of the first patterns p1 is the same as or similar to the description thereof.

The second active material layer 210a2 includes one or more second patterns p2 on a surface thereof. The second patterns p2 correspond to the patterns 213 and/or the sub-patterns 214 shown in FIGS. 5A to 5C and a description of the second patterns p2 is the same as or similar to the description thereof.

Here, when the electrode plate 210 is rolled into the jelly roll shape, the first active material layer 210a1 is rolled to face an interior of the jelly roll shape. In addition, the second active material layer 210a2 is rolled to face an outside of the jelly roll shape. Accordingly, the first active material layer 210a1 may be subjected to greater stress than the second active material layer 210a2 upon rolling.

To solve such a problem, the electrode plate 210 according to an embodiment of the invention is formed such that a number of the second patterns p2 is the same as a number of the first patterns p1, or the number of first patterns p1 is greater than the number of second patterns p2. In an embodiment, for example, the electrode plate 210 is formed such that a distance w1 between the first patterns is equal to or narrower than a distance w2 between the second patterns.

As such, the electrode plate 210 according to an embodiment of the present invention is formed such that the numbers of patterns p1, p2 formed on the surfaces of the active material layers 210 on both surfaces of the base 210a are different from each other. With this structure, the electrode plate according to the embodiment of the present invention can have improved performance as an electrode while minimizing or reducing deformation even when the electrode plate 210 is rolled into the jelly roll shape.

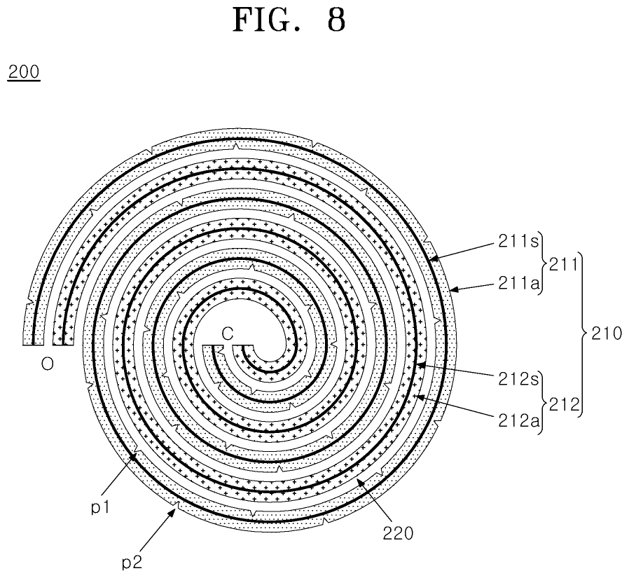

FIG. 8 is a schematic view of an electrode assembly according to an embodiment of the present invention.

In FIG. 8, reference numeral 200 denotes an electrode assembly according to an embodiment of the present invention. In FIG. 8, C indicates a core portion of the electrode assembly 200 and O indicates an outer periphery of the electrode assembly 200.

Referring to FIG. 8, the electrode assembly 200 includes the electrode plate 210 and the separator 220 described with reference to FIG. 5A to FIG. 7. The electrode assembly 200 is formed by stacking the electrode plate 210 and the separator 220. For example, the electrode assembly 200 is formed by stacking the separator 220 between the anode 211 and the cathode 212. The electrode assembly 200 is formed by rolling the laminate into a jelly roll shape.

Here, as described above, at least a portion of the electrode plate 210 according to an embodiment of the present invention may have one or more patterns p1, p2 on the surface thereof. Accordingly, deformation of the electrode assembly 200 can be minimized or reduced.

In an embodiment, the electrode assembly 200 is inserted and/or sealed in a case. An electrolyte is injected into the case together with the electrode assembly 200. In this way, a secondary battery according to an embodiment of the present invention is formed.

Although FIG. 8 shows a structure in which the active material layers 211a, 212a are formed on both surfaces 211s, 212s of the base, in an embodiment, the active material layer may be formed on only one surface of the base, unlike the structure shown in FIG. 8.

In addition, although FIG. 8 shows the structure in which the patterns p1, p2 are formed only on the surface of the anode 211, the patterns may be formed on the surfaces of both the anode 211 and the cathode 212, or only on the surface of the cathode 212, unlike the structure shown in FIG. 8.

In this way, embodiments of the present invention provide the electrode plate and/or the electrode assembly that achieve improvement in deformation characteristics of the core portion, electrolyte impregnation and ion mobility to secure high power/rapid charge characteristics, and/or rapid charge life span without a short circuit at the leading end while reducing precipitation of lithium ions.

Next, some examples of a secondary battery and a battery module to which the electrode plate and/or the electrode assembly according to embodiments of the invention are applied will be described. In addition, an apparatus (for example, a vehicle) adopting a battery pack that includes the secondary battery and/or the battery module will be described below.

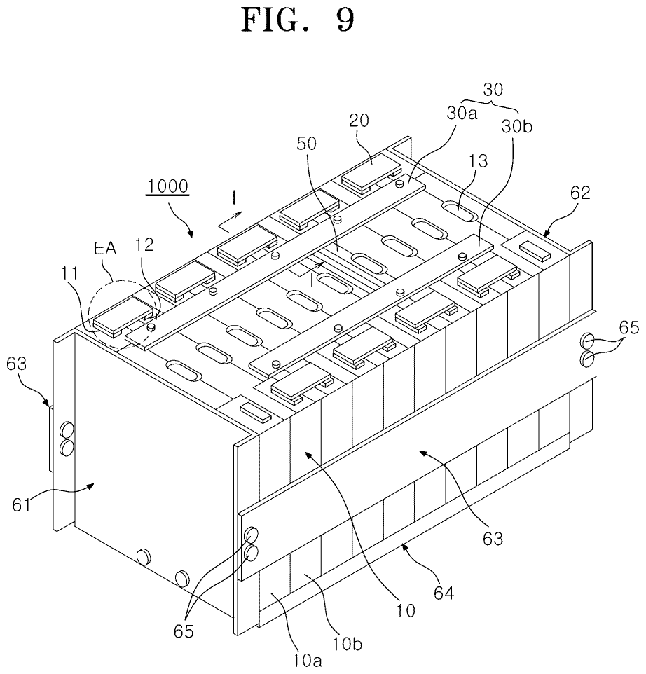

FIG. 9 is a perspective view of a battery module according to an embodiment of the present invention.

In FIG. 9, reference numeral 1000 denotes a battery module. The battery module 1000 includes a plurality of battery cells 10. Here, the battery cells 10 are, for example, lithium secondary batteries or secondary batteries, as described with reference to FIG. 1 to FIG. 8. Each of the battery cells 10 may include, for example, one of the electrode assemblies 200 according to the embodiments of the present invention described with reference to FIG. 3 to FIG. 8, and a case that receives the electrode assembly 200 therein.

Referring to FIG. 9, the battery module 1000 includes a plurality of battery cells 10 each including electrodes, or terminals, 11, 12 and arranged in a direction, connection tabs 20 each connecting two adjacent battery cells 10a, 10b to each other, and a protection circuit module (PCM) 30 connected at a side thereof to the connection tabs 20. The protection circuit module 30 may be a battery management system (BMS). Each of the connection tabs 20 may include a body that contacts the electrodes 11, 12 of the adjacent battery cells 10a, 10b and an extension extending from the body to be connected to the protection circuit module 30. In an embodiment, the connection tab 20 may be a busbar.

The battery cell 10 may include a battery case, and an electrode assembly and an electrolyte received in the battery case. The electrode assembly electrochemically reacts with the electrolyte to generate energy. The battery cell 10 may be provided at a side thereof with terminals 11, 12 electrically connected to the connection tab 20, and may be formed with a vent 13, which is a discharge channel of a gas generated therein. The terminals 11, 12 of the battery cell 10 may be a cathode terminal 11 and an anode terminal 12, respectively, and the terminals 11, 12 of the adjacent battery cells 10a, 10b may be electrically connected in series or in parallel by the connection tabs 20 described below. Although series connection is described above, by way of example, it is to be understood that various connection structures may be used, as desired. In addition, it is to be understood that a number and arrangement of battery cells are not limited to the structure of FIG. 9 and may be changed, as desired.

The plurality of battery cells 10 may be arranged in a direction such that wide surfaces of the battery cells 10 face each other, and may be secured by a housing 61, 62, 63, 64. The housing 61, 62, 63, 64 may include a pair of end plates 61, 62 facing the wide surfaces of the battery cells 10, and side plates 63 and a bottom plate 64 connecting the pair of end plates 61, 62 to each other. Each of the side plates 63 may support a side surface of each of the battery cells 10, and the bottom plate 64 may support a bottom surface of each of the battery cells 10. In an embodiment, the pair of end plates 61, 62, the side plates 63 and the bottom plate 64 may be connected to one another by members, such as bolts 65 or the like.

The protection circuit module 30 may have electronic components and protection circuits mounted thereon and may be electrically connected to the connection tabs 20 described below. In an embodiment, the protection circuit module 30 may include a first protection circuit module 30a and a second protection circuit module 30b extending from different locations in an arrangement direction of the plurality of battery cells 10, wherein the first protection circuit module 30a and the second protection circuit module 30b may be spaced apart parallel to each other by a distance (e.g., a constant distance) and each may be electrically connected to the connection tabs 20 adjacent thereto. For example, the first protection circuit module 30a may extend from a side of upper portions of the plurality of battery cells 10 in an arrangement direction of the plurality of battery cells 10, and the second protection circuit module 30b may extend from another side of the upper portion of the plurality of battery cells 10 in the arrangement direction of the plurality of battery cells 10 such that the second protection circuit module 30b is spaced apart from the first protection circuit module 30a, with the vents 13 disposed therebetween, while being parallel to the first protection circuit module 30a. As such, the two protection circuit modules 30a, 30b may be spaced apart from each other in the arrangement direction of the plurality of battery cells, thereby minimizing or reducing an area of the printed circuit board (PCB) constituting the protection circuit module. An unnecessary PCM area may be minimized or reduced by dividing the protection circuit module into two separate protection circuit modules. In addition, the first protection circuit module 30a and the second protection circuit module 30b may be connected to each other by a conductive connection member 50. The connection member 50 is connected at a side thereof to the first protection circuit module 30a and at another side thereof to the second protection circuit module 30b, whereby electrical connection can be made between the two protection circuit modules 30a, 30b.

The connection may be realized, for example, by any of soldering, resistance welding, laser welding, or projection welding.

The connection member 50 may be, for example, an electrical wire. In an embodiment, the connecting member 50 may be an elastic or flexible material. By such a connection member 50, a voltage, temperature, and current of the plurality of battery cells 10 can be checked and managed to be normal. That is, information, such as voltage, current, and temperature received by the first protection circuit module 30a from the connection tabs adjacent thereto and information, such as voltage, current, and temperature, received by the second protection circuit module 30b from the connection tabs adjacent thereto may be integrated and managed by the protection circuit module through the connection member.

In addition, upon swelling of the battery cells 10, impact can be absorbed by elasticity or flexibility of the connection member 50 to prevent or substantially prevent damage to the first and second protection circuit modules 30a, 30b.

However, a shape and structure of the connecting member 50 are not limited to those shown in FIG. 9.

The structure of the protection circuit module 30 divided into the first and second protection circuit modules 30a, 30b can secure an interior space of the battery module by minimizing or reducing an area of the PCB that constitutes the protection circuit module. This structure improves work efficiency by facilitating not only an operation of connecting the connection tabs 20 to the protection circuit module 30, but also repair upon detection of failure of the battery module.

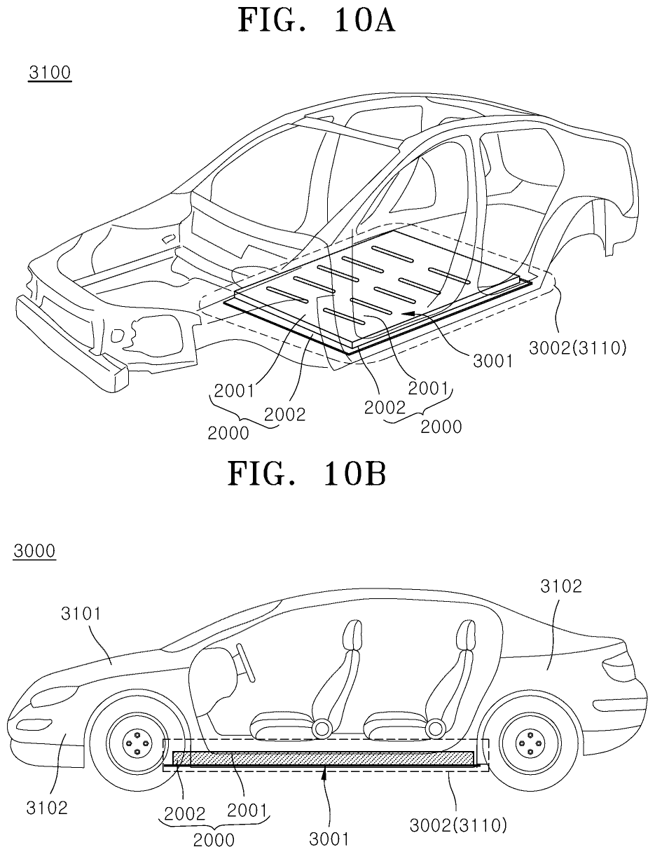

FIG. 10A and FIG. 10B are views of a vehicle body and body parts according to some embodiments of the present invention.

FIG. 10A and FIG. 10B show a vehicle body and body parts including a battery pack (for example, the battery cells 10 of FIG. 9 embedded and/or sealed therein) according to an embodiment of the present invention. In the drawings, components for electrical connection of the batteries, such as busbars, cooling units, external terminals, and the like, are omitted for convenience of illustration.

In FIG. 10A, a battery pack 2000 may include a battery pack cover 2001 as a part of a vehicle underbody 3001 and a pack frame 2002 disposed under the vehicle underbody 3001. In an embodiment, the pack frame 2002 and the battery pack cover 2001 may be integrally formed with the vehicle underbody, or vehicle floor, 3002.

The vehicle underbody 3001 divides the interior and the exterior of the vehicle, and a carrier frame 3002 may be disposed outside the vehicle.

FIG. 10B is a schematic side view of a vehicle according to an embodiment of the present invention.

A vehicle 3000 may include a body 3100 coupled to additional components, such as a hood 3101 at a front side thereof and fenders 3102 at front and rear sides thereof, respectively.

The vehicle 3000 may further include a vehicle floor 3002, which may be one of body parts 3110 including the battery pack 2000 that includes the pack frame 2002, and the battery pack cover 2001.

An automobile according to an embodiment of the present invention includes the battery pack according to an embodiment of the present invention. The automobile may be, for example, an electric automobile, a hybrid automobile, or a plug-in hybrid automobile. The automobile may include a four-wheeled automobile or a two-wheeled automobile. The automobile operates by receiving power from the battery pack according to an embodiment of the present invention.

Although the present invention has been described with reference to some embodiments and drawings illustrating aspects thereof, the present invention is not limited thereto. Rather, various modifications and variations may be made by a person skilled in the art to which the present invention belongs within the scope of the technical spirit of the invention and the claims and equivalents thereto.

What is claimed is:

1. An electrode plate comprising:
a base; and
an active material layer on at least one surface of the base,
wherein the electrode plate comprises a pattern at a first end of the electrode plate,
wherein the first end is a core portion side of the electrode plate.

2. The electrode plate as claimed in claim 1, wherein the pattern comprises one or more stripe-shaped patterns spaced apart from each other.

3. The electrode plate as claimed in claim 1, wherein the pattern comprises a dot-shaped pattern.

4. The electrode plate as claimed in claim 1, further comprising a sub-pattern formed from the pattern toward a second end of the electrode plate, the second end being a rolled distal end side of the electrode plate.

5. The electrode plate as claimed in claim 4, wherein the pattern comprises one or more stripe-shaped patterns spaced apart from each other, and the sub-pattern comprises a dot-shaped pattern.

6. The electrode plate as claimed in claim 1, wherein the pattern is formed within a range from at least one end of a surface of the active material layer.

7. The electrode plate as claimed in claim 6, wherein the range is within a range of 20% or less of a total length of the active material layer from a first side of the surface of the active material layer.

8. The electrode plate as claimed in claim 6, wherein the range is within a range of 5% to 10% of a total length of the active material layer from a side of the surface of the active material layer.

9. The electrode plate as claimed in claim 1,
wherein the active material layer comprises: a first active material layer on a first surface of the base; and a second active material layer on a second surface of the base, and
wherein the pattern comprises a plurality of first patterns on the first active material layer; and one or more second patterns on the second active material layer.

10. The electrode plate as claimed in claim 9, wherein a number of the first patterns is greater than a number of the one or more second patterns.

11. The electrode plate as claimed in claim 9, wherein a distance between the first patterns is narrower than a distance between the one or more second patterns.

12. An electrode assembly comprising a cathode, an anode, and a separator between the cathode and the anode to form a jelly roll shape,
wherein at least one of the cathode and the anode comprises a base; an active material layer on at least one surface of the base; and a pattern at a first end of a surface of the active material layer, the first end being a core portion side of the jelly roll shape.

13. The electrode assembly as claimed in claim 12, wherein the pattern comprises one or more stripe-shaped patterns spaced apart from each other.

14. The electrode assembly as claimed in claim 13, wherein the pattern comprises a dot-shaped pattern.

15. The electrode assembly as claimed in claim 12, wherein at least one of the cathode and the anode further comprises a sub-pattern formed from the pattern toward a second end of the surface of the active material layer, the second end being a rolled distal end side of the jelly roll shape.

16. The electrode assembly as claimed in claim 15, wherein the pattern comprise one or more stripe-shaped patterns spaced apart from each other, and the sub-pattern comprises a dot-shaped pattern.

17. The electrode assembly as claimed in claim 12, wherein the pattern is formed within a range from at least the first end of the surface of the active material layer, the range being a region in a range of 20% or less of a total length of the surface of the active material layer.

18. The electrode assembly as claimed in claim 12,
wherein the active material layer comprises: a first active material layer on a first surface of the base; and a second active material layer on a second surface of the base, and
wherein the pattern comprises a plurality of first patterns on the first active material layer and one or more second patterns on the second active material layer.

19. The electrode assembly as claimed in claim 18, wherein a number of the first patterns is greater than a number of the one or more second patterns.

20. A secondary battery comprising the electrode assembly according to claim 12, and a case receiving the electrode assembly therein.
